(19) United States
(12) Patent Application Publication
(10) Pub. No.: US 2020/0296514 A1
(43) Pub. Date: Sep. 17, 2020

(54) DEVICE, SYSTEM AND METHOD FOR SERVO-CONTROLLED AUDIO SPEAKER

(71) Applicant: Subvo LLC, Draper, UT (US)

(72) Inventors: Joseph Arthur Harris, Draper, UT (US); David Brewster Beck, Draper, UT (US)

(73) Assignee: Subvo LLC, Draper, UT (US)

(21) Appl. No.: 16/351,767

(22) Filed: Mar. 13, 2019

(51) Int. Cl. H04R 9/02; H04R 19/02; H04R 7/04; H04R 3/04; H04R 1/28

(52) U.S. Cl. CPC H04R 9/025; H04R 19/02; H04R 1/2803; H04R 3/04; H04R 7/04

(57) ABSTRACT

Disclosed herein is an audio system having servo-controlled audio speaker and an amplifier. Interposed between the audio speaker and the amplifier is a feedback circuit configured to provide a feedback signal to the amplifier regarding errors and distortions in the operation of the speaker. The feedback circuit includes a flexible sensor connected to the speaker diaphragm and the frame of the speaker. The flexible sensor changes its resistance responsive to changes in its shape. The feedback signal is used by the amplifier to apply corrections to the drive signal for the audio speaker.

### CROSS-REFERENCE TO RELEATED APPLICATIONS

Not applicable.

### BACKGROUND

### 1. Technical Field

This disclosure relates generally to audio speakers and more particularly, but not necessarily entirely, to servo-controlled audio speakers.

### 2. Description of the Related Art

Audio speakers produce sound by converting an electrical signal into mechanical energy. Referring to FIG. 1, there is shown a diagram of a conventional audio speaker assembly 100 with its constituent components. The speaker assembly 100 includes a back plate 102, a pole 104, a permanent magnet 106, a top plate 108, a basket or frame 110, a voice coil 112, a spider 114, a diaphragm or cone 116, and a dust cap 118.

The voice coil 112 consists of a coil of wire that terminates at each end in a positive lead 120 and a negative lead 122. In addition, the voice coil 112 is connected to the frame 110 by the spider 114. The spider 114, a ring of flexible material, holds the voice coil 112 in position and allows the voice coil 112 to slide back and forth over the pole 104. The voice coil 112 is also connected to the narrow end of the diaphragm 116 such that when the voice coil 112 moves the diaphragm 116 will move as well.

In addition, there are other diaphragm moving technologies that include a piezoelectric substrate that deflects with respect to the incoming voltage signal. There are also electrostatic speakers that use a mylar sheet or diaphragm between two charged electrodes that varies position based on the incoming voltage signal. Such technologies may be utilized by the disclosure.

Referring to FIG. 2, there is shown a conventional audio system 200. The audio system 200 includes an amplifier 202 connected to the audio speaker 100. In particular, the amplifier 202 includes a first lead 204 that is connected to the positive lead 120 of the voice coil 112 and a second lead 206 that is connected to the negative lead 122 of the voice coil 112. The amplifier 202 is connected to a sound source 208 that provides an input signal to the amplifier 202. The input signal from the source may be a digital or an analog signal.

In operation, the amplifier 202 amplifies the input signal and provides a drive signal to the voice coil 112 through its positive lead 120. Essentially, the amplifier 202 is constantly switching the electrical signal, fluctuating between a positive charge and a negative charge, on the positive lead 120. The current going through the voice coil 112 moves one way and then reverses and flows the other way. This alternating current causes the polar orientation of the electromagnet formed by the voice coil 112 and pole 104 to reverse itself many times a second. That is, when the electrical current flowing through the voice coil 112 changes direction, the polar orientation of the voice coil 112 reverses. This changes the magnetic forces between the voice coil 112 and the permanent magnet 106 and moves the voice coil 112 and attached diaphragm 116 back and forth to produce sound. Stated another way, when the voice coil 112 moves, it pushes and pulls on the speaker diaphragm 116. This movement vibrates the air in front of the speaker diaphragm 116 to create sound waves.

Because audio speakers use mechanical movement to generate sound, they are plagued with errors and distortions that corrupt the sound. There are many factors in the construction of the speakers that cause these errors. Voice coils, which are inductors, exhibit counter forces which hinder changing voltages and currents. Further, speakers are complex systems which exhibit mechanical and electrical resonances that favor certain frequencies. In addition, the diaphragm of a speaker is a mass which has momentum and takes time to change directions. Lastly, the speaker baffle, the surface to which on which the speaker is mounted, acts as a spring that applies non-linear forces on the diaphragm.

Attempts have been made to reduce errors and distortions in audio speakers. A servo-controlled speaker system uses a feedback loop to correct for performance errors and distortion introduced by the speaker. That is, in a servo-controlled system, if the diaphragm fails to move exactly in accordance with the drive signal, the error is measured, and the input signal is modified by the amplifier to correct the error. The feedback loop consists of a sensor that converts the position or movement of the diaphragm of the speaker into an electrical signal that is fed back into the amplifier. The amplifier may then apply corrections to the drive signal to the speaker voice coil.

The effectiveness of the servo-controlled loudspeaker system is highly dependent on the performance of the feedback sensor. Unfortunately, many sensors used in servo-controlled loudspeakers are also inherently non-linear and therefore introduce their own errors and distortions into the system. Additional signal conditioning circuitry is required to compensate for these errors. This additional circuitry can add delays in the feedback loop that reduce the effectiveness of the feedback system.

Another common feedback sensor technique is to use a secondary voice coil that is used to determine the position of the diaphragm. To generate the return signal in the secondary voice coil, the diaphragm must be moving. Essentially, the secondary voice coil measures the velocity of the diaphragm. To determine the actual diaphragm position, the signal must be integrated. However, this step also produces additional error and delay.

Another common feedback sensor uses an accelerometer mounted on the diaphragm, usually under the dust cover. The accelerometer measures the acceleration of the diaphragm. This requires two-steps of integration to determine the diaphragm position. One integration step determines velocity and the other determines position. Unfortunately, this two-step process adds even more error and delay than the secondary voice coil method. Another disadvantage of currently available servo-controlled speakers is that they are too slow to operate with high frequency sounds.

Accordingly, it is an object of this disclosure to provide a servo-controlled speaker with a sensor that provides the actual position of the speaker diaphragm without the need for additional integration steps.

It is an object of this disclosure to provide a highly accurate sensor to give feedback information on a position of a speaker diaphragm at a speed well above the audible range.

It is an object of this disclosure to provide a servo-controlled speaker with a position feedback system for the diagram with reduced error and delay in the response.

### SUMMARY

Disclosed herein is a device, system, and method for servo-controlled audio speakers. The audio speaker may include a diaphragm, a frame, and a flexible sensor. The flexible sensor may be connected to the diaphragm and the frame.

The audio system may include a speaker having a diaphragm and a frame; an amplifier configured to provide a drive signal to the speaker; and a feedback circuit coupled between the speaker and the amplifier. The feedback circuit may comprise a flexible sensor and the flexible sensor may be connected to the diaphragm and the frame of the speaker. The feedback circuit may be configured to provide a feedback signal to the amplifier.

The method of driving a speaker may include a speaker having a diaphragm and a frame. The method may include providing a drive signal to the speaker that causes movement of the diaphragm; monitoring the movement of the diaphragm using a feedback circuit, where the feedback circuit may comprise a flexible sensor connected to the diaphragm and the frame; wherein the flexible sensor varies a physical property responsive to a position of the diaphragm.

### BRIEF DESCRIPTION OF THE DRAWINGS

The accompanying drawings illustrate various embodiments of the present disclosure. Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 illustrates an exploded view of a conventional audio speaker;

FIG. 2 is a diagram of a conventional audio system with a source, amplifier and speaker;

FIG. 3 is a sideview of an audio speaker with a flexible sensor mounted between the outer side of the cone and the frame;

FIG. 4 is a diagram of a servo-controlled audio system which uses a feedback circuit for error correction according to an embodiment of the present disclosure;

FIG. 5 is a schematic showing a feedback circuit according to an embodiment of the present disclosure; and

FIG. 6 is a schematic showing a feedback circuit according to an embodiment of the present disclosure.

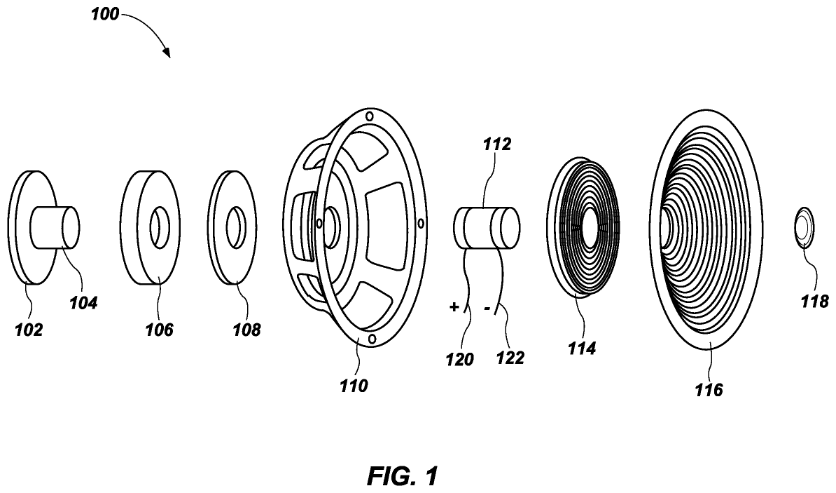

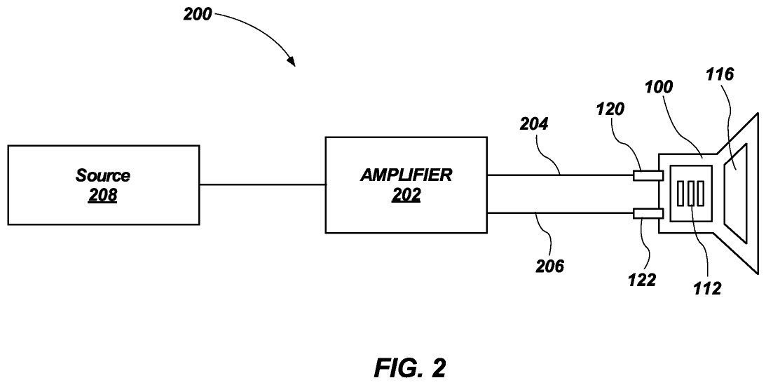

### DETAILED DESCRIPTION

The disclosure extends to devices, systems, and methods for an audio system having servo-controlled audio speaker and an amplifier. Interposed between the audio speaker and the amplifier is a feedback circuit configured to provide a feedback signal to the amplifier regarding errors and distortions in the operation of the speaker. The feedback circuit includes a flexible sensor connected to the speaker diaphragm and the frame of the speaker. The flexible sensor changes its resistance responsive to changes in its shape. The feedback signal is used by the amplifier to apply corrections to the drive signal for the audio speaker. In the following description of the disclosure, reference is made to the accompanying drawings, which form a part hereof, and in which is shown by way of illustration specific implementations in which the disclosure is may be practiced. It is understood that other implementations may be utilized and structural changes may be made without departing from the scope of the disclosure.

Disclosed herein is a device, system, and method for servo-controlled audio speakers. The audio speaker may include a diaphragm, a frame, and a flexible sensor. The flexible sensor may be connected to the diaphragm and the frame.

The audio system may include a speaker having a diaphragm and a frame; an amplifier configured to provide a drive signal to the speaker; and a feedback circuit coupled between the speaker and the amplifier. The feedback circuit may comprise a flexible sensor and the flexible sensor may be connected to the diaphragm and the frame of the speaker. The feedback circuit may be configured to provide a feedback signal to the amplifier.

The method of driving a speaker may include a speaker having a diaphragm and a frame. The method may include providing a drive signal to the speaker that causes movement of the diaphragm; monitoring the movement of the diaphragm using a feedback circuit, where the feedback circuit may comprise a flexible sensor connected to the diaphragm and the frame; wherein the flexible sensor varies a physical property responsive to a position of the diaphragm.

Also disclosed herein is a feedback system for an audio speaker that reduces, and in some cases eliminates, errors and distortions in sound produced by the audio speaker.

Further disclosed herein is a servo-controlled audio system that has an amplifier, a loudspeaker and a feedback circuit. The feedback circuit comprises a resistive flexible sensor that is mechanically secured to the diaphragm of the loudspeaker on one end and to the frame of the loudspeaker on the other end. The flexible sensor changes shape as the diaphragm deflects in both the positive and negative direction in response to a drive signal from the amplifier. As the flexible senor bends responsive to the deflection of the diaphragm, a physical property of the flexible sensor varies in a predictable manner to thereby generate a feedback signal with information regarding the position of the diaphragm. The variable physical property of the flexible sensor may be one of resistance, capacitance, electric charge or the ability to transmit light. The feedback signal is then fed back into the amplifier. The amplifier then corrects errors and distortions in the speaker by modifying the drive signal to the speaker.

Further disclosed herein is a feedback system for an audio speaker that incorporates a flexible sensor for determining the position of a speaker diaphragm during operation.

Further disclosed herein is a feedback circuit for an audio speaker that converts mechanical movement of the speaker diaphragm into an electrical signal using a flexible sensor.

Further disclosed herein is a feedback system for an audio speaker that reduces, and in some cases eliminates, errors and delays in the feedback signal with position information regarding the speaker diaphragm.

Further disclosed herein is a feedback system for an audio speaker may also be used on speakers that produce frequencies in the range of about 20 Hz to 20,000 Hz. Also disclosed herein is a feedback system for an audio speaker that is able to be used on speakers that produce high frequencies, such as tweeters, typically from around 2,000 Hz to 20,000 Hz.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

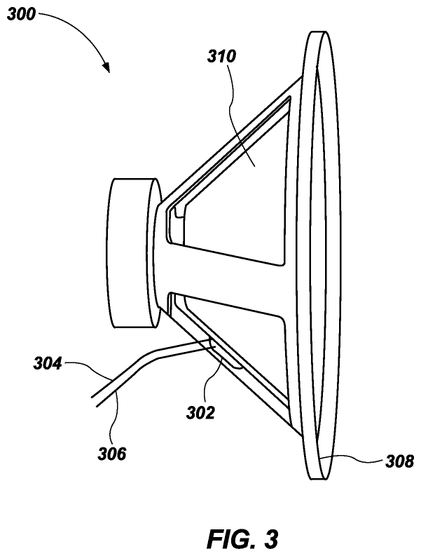

Referring to FIG. 3, an audio speaker 300 according to the present disclosure includes essentially the same components of the speaker 100, only some of which are identified in the discussion below. The audio speaker 300 includes a frame 308 and a diaphragm 310. Mounted to the frame 308 is a flexible sensor 302 having a first end and a second end. The first end of the flexible sensor 302 is attached to the frame 308 and the second end of the flexible sensor 302 is attached to an outer surface of the diaphragm 310. When mounted, the flexible sensor 302 includes a slight curvature or bend in a neutral position. The flexible sensor 302 further includes a first lead 304 and a second lead 306 for incorporating the sensor 302 into a feedback circuit.

Due to its connection points and configuration, the flexible sensor 302 deflects as the diaphragm 310 moves in response to a drive signal from an amplifier. It will be appreciated that the flexible sensor 302 changes a physical property in a predictable manner when the flexible sensor 302 is deflected by the diaphragm 310. The physical property of the flexible sensor 302 may include one of resistance, capacitance, electrical charge and the ability to transmit light. The physical property may vary dependent on a shape of the flexible sensor.

In an embodiment, the flexible sensor 302 comprises a flexible resistor that varies its electrical resistance in a predictable manner when the flexible sensor 302 is deflected or bent. That is, the flexible resistor changes its electrical resistance dependent upon its shape. Therefore, the flexible resistor converts mechanical movement of the diaphragm 310 into an electrical signal dependent on the shape of the flexible sensor 302. The flexible resistor may include a conductive epoxy-based carbon ink material deposited or printed on a polyimide or polyester substrate. The substrate is also flexible, such that it can be deflected or bent. The flexible sensor is microscopically cracked so that as it bends or changes shape the microscopic cracks open up, thereby increasing the resistance. A suitable flexible sensor with a flexible resistor for use with the present disclosure is manufactured by Flexpoint Sensor Systems Inc. of Draper, Utah.

In an embodiment, the flexible sensor 302 comprises a flexible capacitor that varies its capacitance in a predictable manner as the flexible sensor 302 bends and changes shape.

In an embodiment, the flexible sensor 302 comprises a piezoelectric material that generates a current in response to mechanical stress. The piezoelectric material is connected to the diaphragm and the frame of a speaker such that movement of the diaphragm generates a current.

In an embodiment, the flexible sensor 302 comprises an optical flex sensor and a photosensitive detector that changes its resistance in a predictable manner with light intensity. The optical flex sensor is connected to the diaphragm and the frame such that movement of the diaphragm changes the shape of the optical flex sensor and the transmission of light through the optical flex sensor.

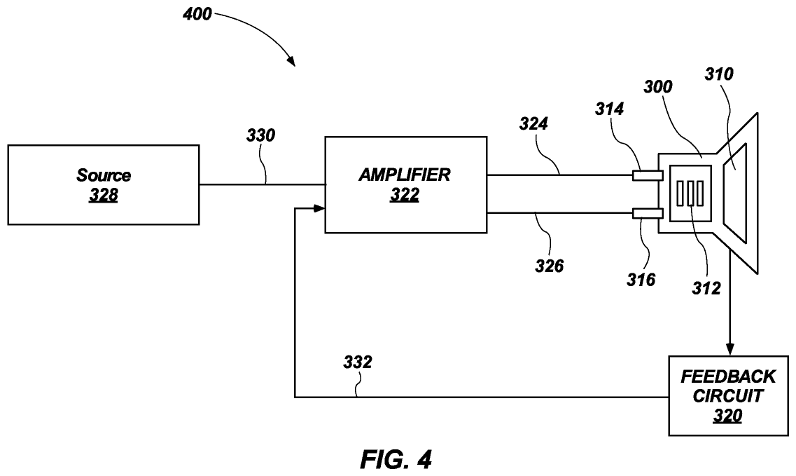

Referring now to FIG. 4, an audio system 400 according to the present disclosure includes the speaker 300, an amplifier 322, and an audio source 328. In addition, coupled between the speaker 300 and the amplifier 322 is a feedback circuit 320. A first lead 324 of the amplifier 322 is connected to a positive lead 314 of a voice coil 312 of the speaker 300. A second lead 326 of the amplifier 322 is connected to a negative lead 316 of the voice coil 312. The source 328 provides a source signal to the amplifier 322 over a connection 330. The connection 330 may be wired or wireless.

The amplifier 322 provides a drive signal to the voice coil 312 through the positive lead 314. The drive signal may be an amplified version of the source signal provided by the source 328. In response to the drive signal, the voice coil 312 causes the diaphragm 310 to move in order to generate sound from the speaker 300.

The feedback circuit 320 provides a feedback signal to the amplifier 322 over a connection 332. The feedback signal may include information regarding a position of the diaphragm 310 of the speaker 300. The amplifier 322 uses the information in the feedback signal to correct for performance errors and distortion introduced by the physical limitations of the speaker 300. In an embodiment, the amplifier 322 subtracts the feedback signal from the source signal to determine an error signal. The error signal is added to the source signal to generate a modified drive signal that compensates for the performance errors in the speaker 300.

In addition to traditional speakers, the disclosure may be utilized with other diaphragm moving technologies. One such diaphragm moving technology comprises a piezoelectric substrate that deflects with respect to the incoming voltage signal. Another such diaphragm moving technology comprises an electrostatic speaker that has a mylar sheet or diaphragm between two charged electrodes that varies position based on the incoming voltage signal. These, and any other, diaphragm moving technology may be utilized by the disclosure.

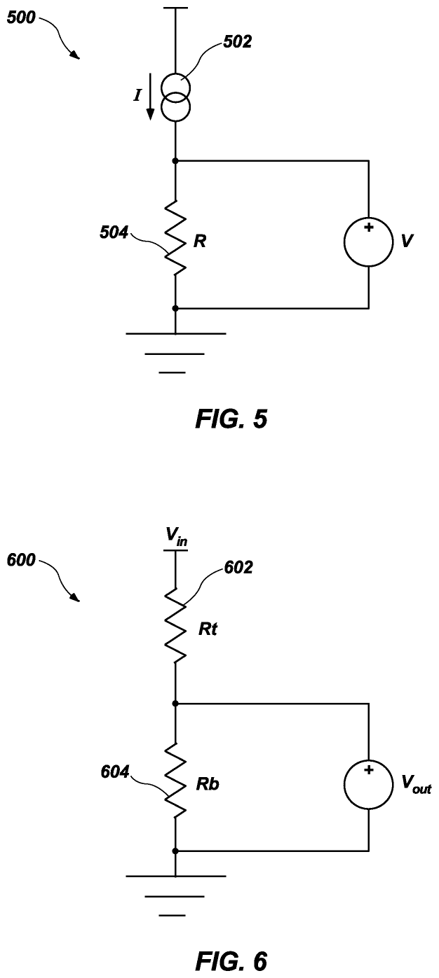

Referring to FIG. 5, there is depicted a schematic of a circuit 500 suitable for use in the feedback circuit 320 shown in FIG. 4. The circuit 500 includes a current source 502 and a flexible sensor 504 that includes a flexible resistor. A current from the current source 502 generates a voltage across the flexible sensor 504 in accordance with Ohm's Law which states that V=IR, where V is the voltage, R is resistance and I is current. The flexible sensor 504 varies its resistance as it deflects responsive to movement of the diaphragm 310. Thus, the voltage across the flexible sensor 504 varies responsive to movement of the diaphragm.

Referring to FIG. 6, there is depicted a schematic of a circuit 600 suitable for use in the feedback circuit 320 shown in FIG. 4. The circuit 600 includes a top resistor 602 in series with a bottom resistor 604. The voltage divider equation is Vout=Vin(Rb)/(Rb+Rt). In this circuit 600, the flexible sensor can be substituted in place of the top resistor 602 or the bottom resistor 604.

It will be appreciated that a flexible sensor has distinct advantages over existing sensor technologies used in servo-controlled loudspeakers. The first major advantage is that it gives the actual position of the speaker diaphragm without the need for any integration steps. Therefore, there is no error in position and there is no delay in the response of the flexible sensor and the position of the diaphragm. The second major advantage of the flexible sensor is that it reacts very fast and can even track a diaphragm in the range of 2 kHz to 20 kHz or above 5 kHz, or above 8 kHz, or above 10 kHz, or above 12 kHz, or above 15 kHz, or even well above the audible range of 20 kHz. This allows servo control of speakers that produce higher frequencies like tweeters whereas previous sensor technologies can only keep up with subwoofer frequencies, typically 20-200 Hz.

The foregoing description has been presented for purposes of illustration and description. It is not intended to be exhaustive or to limit the disclosure to the precise forms or embodiments disclosed. Many modifications, variations, and adaptations will be apparent to those skilled in the art from consideration of the above teachings, specification, and practice of the disclosed embodiments. For example, components described herein may be removed and other components added without departing from the scope or spirit of the embodiments disclosed herein or the appended claims. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

1. An audio speaker comprising:
a diaphragm;
a frame;
a rim; and
a flexible sensor;
wherein the flexible sensor is connected to the diaphragm and the frame.

2. The audio speaker of claim 1, further comprising a permanent magnet and a voice coil, wherein the voice coil is coupled to the diaphragm.

3. The audio speaker of claim 1, further comprising a piezoelectric substrate coupled to the diaphragm.

4. The audio speaker of claim 1, further comprising an electrostatic speaker comprising a mylar diaphragm between one or more charged electrodes.

5. The audio speaker of claim 1, wherein the flexible sensor comprises a conductive material deposited on a flexible substrate.

6. The audio speaker of claim 1, wherein the flexible sensor comprises a piezoelectric material.

7. The audio speaker of claim 1, wherein the flexible sensor comprises an optical flex sensor and a photosensitive detector that changes its resistance with light intensity.

8. The audio speaker of claim 1, wherein the flexible sensor comprises a capacitor.

9. The audio speaker of claim 1, wherein the flexible sensor changes its resistance responsive to its shape.

10. The audio speaker of claim 1, wherein the speaker provides sound in the range of about 20 Hz to about 20,000 Hz.

11. The audio speaker of claim 1, wherein the speaker provides sound in the range of about 2,000 Hz to about 20,000 Hz.

12. The audio speaker of claim 1, wherein the flexible sensor comprises a first end and a second end, wherein the first end is mechanically secured to diaphragm and the second end is secured to the frame.

13. An audio system comprising:
a speaker having a diaphragm, a frame, and a rim;
an amplifier configured to provide a drive signal to the speaker;
a feedback circuit coupled between the speaker and the amplifier;
wherein the feedback circuit comprises a flexible sensor;
wherein the flexible sensor is connected to the diaphragm and the frame of the speaker;
wherein the feedback circuit is configured to provide a feedback signal to the amplifier.

14. The audio system of claim 13, wherein the feedback signal comprises position information regarding the diaphragm.

15. The audio system of claim 13, wherein the flexible sensor comprises a conductive material deposited on a substrate.

16. The audio system of claim 13, wherein the flexible sensor comprises a piezoelectric material.

17. The audio system of claim 13, wherein the flexible sensor comprises an optical flex sensor and a photosensitive detector that changes its resistance with light intensity.

18. The audio system of claim 13, wherein the flexible sensor comprises capacitor.

19. The audio system of claim 13, wherein the flexible sensor changes its resistance responsive to its shape.

20. The audio system of claim 13, wherein the speaker provides sound in the range of about 20 Hz to about 20,000 Hz.

21. The audio system of claim 13, wherein the speaker provides sound in the range of about 2,000 Hz to about 20,000 Hz.

22. The audio system of claim 13, further comprising a piezoelectric substrate coupled to the diaphragm.

23. The audio system of claim 13, further comprising an electrostatic speaker comprising a mylar diaphragm between one or more charged electrodes.

24. The audio system of claim 13, wherein the flexible sensor comprises a first end and a second end, wherein the first end is mechanically secured to diaphragm and the second end is secured to the frame.

25. A method of driving a speaker, the speaker having a diaphragm, a frame, and a rim, said method comprising:
providing a drive signal to the speaker that causes movement of the diaphragm;
monitoring the movement of the diaphragm using a feedback circuit, the feedback circuit comprising a flexible sensor connected to the diaphragm and the frame;
wherein the flexible sensor varies a physical property responsive to a position of the diaphragm.

26. The method of claim 25, wherein the physical property is one of resistance, capacitance, electrical charge and light transmissivity.

27. The method of claim 25, wherein the flexible sensor comprises a conductive material deposited onto a flexible substrate.

28. The method of claim 25, wherein the flexible sensor changes its physical property responsive to its shape.

29. The method of claim 25, further comprising providing a feedback signal from the feedback circuit to an amplifier.

30. The method of claim 29, further comprising correcting errors in the drive signal based on the feedback signal.

31. The method of claim 25, wherein the sound generated by the speaker is in the range of about 20 Hz to about 20,000 Hz.

32. The method of claim 25, wherein the sound generated by the speaker is in the range of about 2,000 Hz to about 20,000 Hz.

33. The method of claim 25, further comprising a piezoelectric substrate coupled to the diaphragm.

34. The method of claim 25, further comprising an electrostatic speaker comprising a mylar diaphragm between one or more charged electrodes.

35. The method of claim 25, wherein the flexible sensor comprises a first end and a second end, wherein the first end is mechanically secured to diaphragm and the second end is secured to the frame.
